(19) United States
(12) Patent Application Publication
(10) Pub. No.: US 2015/0097507 A1
(43) Pub. Date: Apr. 9, 2015

(54) MOTOR DRIVING APPARATUS

(71) Applicant: SAMSUNG ELECTRO-MECHANICS CO., LTD., Suwon-Si (KR)

(72) Inventors: Han Tae KIM, Suwon-Si (KR); Min Sup SONG, Suwon-Si (KR); Kyeoung Hun PARK, Suwon-Si (KR)

(73) Assignee: SAMSUNG ELECTRO-MECHANICS CO., LTD., Suwon-Si (KR)

(21) Appl. No.: 14/267,246

(22) Filed: May 1, 2014

(30) Foreign Application Priority Data
Oct. 4, 2013 (KR) 10-2013-0118718

(51) Int. Cl. H02P 27/06

(52) U.S. Cl. CPC H02P 27/06
USPC 318/504

(57) ABSTRACT

A motor driving apparatus may include a bidirectional converter including an energy storage unit and converting power bidirectionally; an inverter receiving the power from the bidirectional converter and driving a motor; and a power passing unit transferring energy stored in the energy storage unit of the bidirectional converter to the inverter.

### CROSS-REFERENCE TO RELATED APPLICATION

This application claims the benefit of Korean Patent Application No. 10-2013-0118718 filed on Oct. 4, 2013, with the Korean Intellectual Property Office, the disclosure of which is incorporated herein by reference.

### BACKGROUND

The present disclosure relates to a motor driving apparatus having enhanced efficiency.

An inverter is an alternating current/direct current (AC/DC) power converter converting DC power into AC power and transmitting average power to an AC side from a DC side. Such an inverter may be classified as a voltage source inverter or a current source inverter according to a power type thereof.

The voltage source inverter may receive power from a DC voltage source (battery) and function as an electric motor (motor). In general, limitations may arise in that, when an inverter functions as an electric motor, a voltage of a battery tends to decrease, and as the electric motor continuously operates at a low voltage, the performance and efficiency of the electric motor are degraded.

When an inverter functions as a generator, a battery is charged with a regenerated voltage to charge the inverter with power required for the inverter. However, a regenerated voltage having a high voltage level may not be uniform and repeatedly charged, and thus, the lifespan of a battery may be reduced.

### RELATED ART DOCUMENT

(Patent Document 1) Korean Patent Laid-Open Publication No. 10-2011-0062374

### SUMMARY

An aspect of the present disclosure may provide a motor driving apparatus capable of boosting and reducing a voltage bidirectionally with high efficiency, using an inverter structure including a bidirectional switching converter disposed in front of a DC link capacitor used as a main power source of a voltage source inverter.

According to an aspect of the present disclosure, a motor driving apparatus may include: a bidirectional converter including an energy storage unit and converting power bidirectionally; an inverter receiving the power from the bidirectional converter and driving a motor; and a power passing unit transferring energy stored in the energy storage unit of the bidirectional converter to the inverter.

The bidirectional converter may include a first inductor connected between a first node and a second node; a first switching device connected between the second node and abase power source and switched according to a first switching signal; a separation capacitor connected between the second node and a third node; a second inductor connected between the third node and the base power source; and a second switching device connected between the third node and a fourth node.

The motor driving apparatus may further include an input capacitor connected between the first node and the base power source; and an output capacitor connected between the fourth node and the base power source.

The power passing unit may be formed between the second node and the fourth node.

The power passing unit may include a third switching device, a fourth switching device, and an auxiliary inductor connected to one another in series.

According to another aspect of the present disclosure, a motor driving apparatus may include: a SEPIC and ZETA converter including an energy storage unit and converting power bidirectionally; an inverter receiving the power from the SEPIC and ZETA converter and driving a motor; and a power passing unit transferring energy stored in the energy storage unit of the SEPIC and ZETA converter to the inverter.

The SEPIC and ZETA converter may include a first inductor connected between a first node and a second node; a first switching device connected between the second node and abase power source and switched according to a first switching signal; a separation capacitor connected between the second node and a third node; a second inductor connected between the third node and the base power source; and a second switching device connected between the third node and a fourth node.

The motor driving apparatus may further include an input capacitor connected between the first node and the base power source, and an output capacitor connected between the fourth node and the base power source.

The power passing unit may be formed between the second node and the fourth node.

The power passing unit may include a third switching device, a fourth switching device, and an auxiliary inductor connected to one another in series.

An input power unit may be connected between the first node and the base power source, and the inverter may be connected between the fourth node and the base power source.

A load may be connected between the first node and the base power source, and the inverter may be connected between the fourth node and the base power source to receive power from the inverter.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic block diagram illustrating a motor driving apparatus according to an embodiment of the present disclosure;

FIG. 2 is a schematic diagram illustrating a motor driving apparatus according to an embodiment of the present disclosure;

FIG. 3 is a circuit diagram illustrating a simulation test of the motor driving apparatus illustrated in FIG. 2;

FIG. 4 illustrates waveforms of components of the circuit illustrated in FIG. 3;

FIG. 5 is a circuit diagram illustrating a simulation test of the motor driving apparatus illustrated in FIG. 2; and

FIG. 6 illustrates waveforms of components of the circuit illustrated in FIG. 5.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

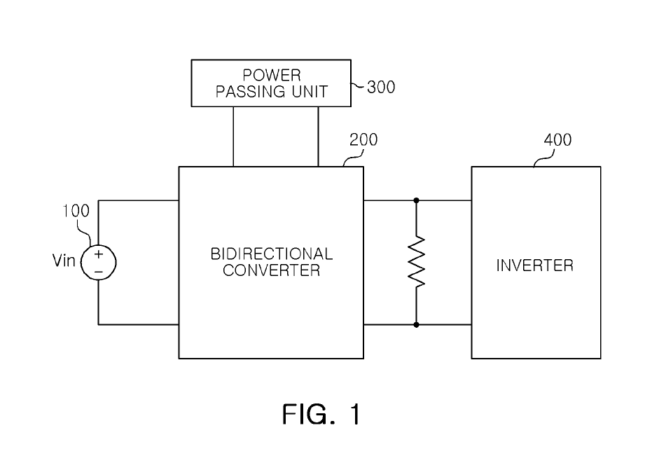

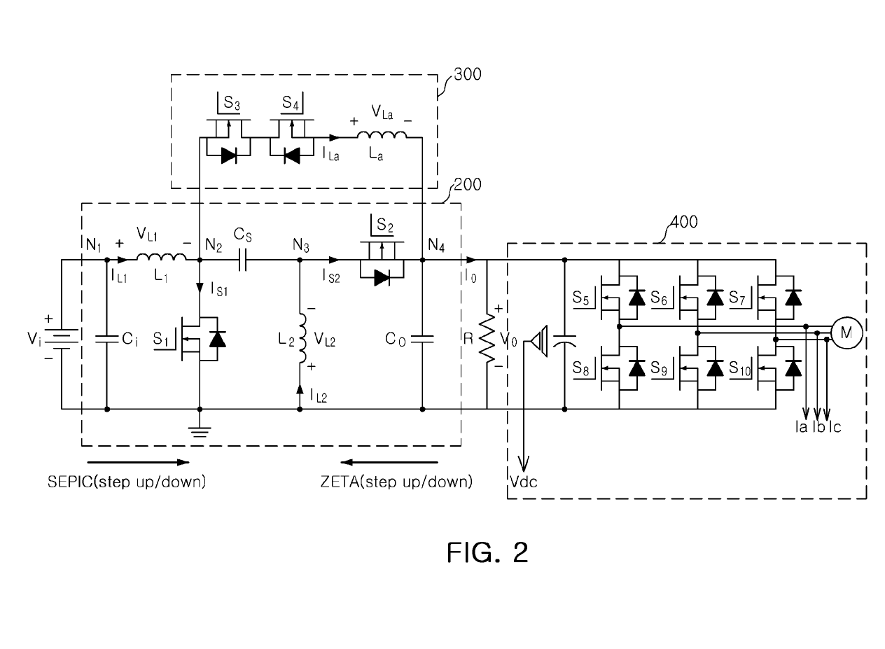

FIG. 1 is a schematic block diagram illustrating a motor driving apparatus according to an embodiment of the present disclosure. FIG. 2 is a schematic diagram illustrating a motor driving apparatus according to an embodiment of the present disclosure.

Referring to FIGS. 1 and 2, a motor driving apparatus according to an embodiment of the present disclosure may include an input power unit 100, a bidirectional converter 200, a power passing unit 300, and an inverter 400.

The bidirectional converter 200 is a converter that controls a flow of power bidirectionally. When a voltage level of a voltage source such as a battery, or the like is low, the bidirectional converter 200 may function in a boost mode. On the other hand, when the voltage level of the voltage source is high, the bidirectional converter 200 may function in a buck mode.

According to an embodiment of the present disclosure, single-ended primary-inductor converter (SEPIC) and ZETA (known as inverted SEPIC) topology may be applied to the bidirectional converter 200. An SEPIC converter and a ZETA converter may boost and reduce a voltage.

The SEPIC and ZETA converter may operate as an SEPIC converter in one direction and operate as a ZETA converter in another direction.

That is, in an existing SEPIC converter and a ZETA converter, when a circuit is configured by converting a diode device into an active switching device as illustrated in FIG. 2, the SEPIC and ZETA converter may operate as an SEPIC converter in a direction indicated by a right-directional arrow and operate as a ZETA converter in a direction indicated by a left-directional arrow.

Thus, the bidirectional converter 200 may operate as a DC/DC converter that boosts and reduces a voltage bidirectionally.

According to an embodiment of the present disclosure, the motor driving apparatus may operate as a bidirectional SEPIC and ZETA converter. That is, according to an embodiment of the present disclosure, the motor driving apparatus may operate as an SEPIC converter in one direction and operate as a ZETA converter in another direction.

For convenience of description, according to an embodiment of the present disclosure, a case in which the bidirectional converter 200 operates as an SEPIC converter will be described below.

The input power unit 100 is connected between a base power source and a first node N1 of the bidirectional converter 200. The input power unit 100 may supply an input voltage to the bidirectional converter 200 at a predetermined level and may be a wall power source or a battery.

The bidirectional converter 200 includes an input capacitor Ci, a first inductor L1, a first switching device S1, a separation capacitor Cs, a second inductor L2, a second switching device S2, and an output capacitor Co.

The input capacitor Ci is connected between the first node N1 and the base power source. The input capacitor Ci stores a voltage applied from an input power source Vi according to switching of the first switching device S1 and outputs the stored energy.

The first inductor L1 is connected between the first node N1 and a second node N2. That is, one end of the first inductor L1 is connected to the first node N1 and the other end thereof is connected to one end of the separation capacitor Cs through the second node N2. The first inductor L1 stores energy supplied from the input power source Vi and/or the input capacitor Ci according to switching of the first switching device S1 and outputs the stored energy.

The first switching device S1 may be switched according to a first switching signal having a predetermined on-duty, supplied from an external duty controller (not shown) and may control a current flow in the bidirectional converter 200.

To this end, the first switching device S1 includes a gate terminal to which the first switching signal is supplied, a drain terminal connected to the second node N2, and a source terminal connected to the base power source.

The first switching device S1 may be a field effect transistor (FET), an insulated gate bipolar transistor (IGBT), or an integrated gate commutated thyristor (IGCT).

The first switching device S1 may further include an internal diode formed to be biased in a forward direction from the source terminal to the drain terminal.

The separation capacitor Cs is connected between the second node N2 and a third node N3. That is, one end of the separation capacitor Cs is connected to the second node N2 and the other end thereof is connected to the third node N3. The separation capacitor Cs stores energy according to switching of the first switching device S1 and outputs the stored energy to a load.

The second inductor L2 is connected between the third node N3 and the base power source. That is, one end of the second inductor L2 is connected to the third node N3 and the other end thereof is connected to the base power source. The second inductor L2 stores energy supplied thereto according to switching of the first switching device S1 and outputs the stored energy to a load, or outputs the energy to the separation capacitor Cs and charges the separation capacitor Cs with the energy.

The second switching device S2 may be switched according to a second switching signal having a predetermined on-duty, supplied from an external duty controller (not shown) and may control a current flow in the bidirectional converter 200.

To this end, the second switching device S2 may include a gate terminal to which the second switching signal is supplied, a drain terminal connected to the third node N3, and a source terminal connected to a fourth node N4.

The second switching device S2 may be a field effect transistor (FET), an insulated gate bipolar transistor (IGBT), or an integrated gate commutated thyristor (IGCT).

The second switching device S2 may further include an internal diode formed to be biased in a forward direction from the source terminal to the drain terminal.

The internal diode formed in the second switching device S2 is connected between the third node N3 and the fourth node N4. That is, an anode terminal of the internal diode is connected to the third node N3 and a cathode terminal is connected to the fourth node N4.

The internal diode may be in a conduction state according to a voltage level between the third node N3 and the fourth node N4 to output energy stored in the first and second inductors L1 and L2 to the fourth node N4. In addition, the internal diode may block backward current that flows toward the third node N3 from the fourth node N4.

The output capacitor Co is connected between the fourth node N4 and the base power source. That is, one end of the output capacitor Co is connected to the fourth node N4 and the other end thereof is connected to the base power source.

When the first switching device S1 is turned on, the output capacitor Co may constantly smoothen and store a voltage output to a load through the fourth node N4. When the first switching device S1 is turned off, the first switching device S1 may output the stored voltage to the load through the fourth node N4.

Here, the load may be a light emitting diode (LED), an LED array, a backlight unit, various information devices, a display apparatus, or the like.

When the first switching device S1 is turned on according to the first switching signal, the bidirectional converter 200 may charge the first inductor L1 and at the same time, charge the second inductor L2 through discharging energy stored in the separation capacitor Cs. When the first switching device S1 is turned off according to the first switching signal, the energy stored in the first and second inductors L1 and L2 may be output to the fourth node N4 and may be charged in the output capacitor Co.

The power passing unit 300 may form an additional power transfer path and include a third switching device S3, a fourth switching device S4, and an auxiliary inductor device La. Here, the third switching device S3, the fourth switching device S4, and the auxiliary inductor device La may be connected to one another in series.

One end of the third switching device S3 may be connected to the second node N2 and one end of the auxiliary inductor device La may be connected to the fourth node N4.

The third switching device S3 may further include an internal diode that is formed to be biased in a forward direction from a source terminal to a drain terminal. In addition, the fourth switching device S4 may further include an internal diode that is formed to be biased in a forward direction from a source terminal to a drain terminal.

The drain terminal of the third switching device S3 and the drain terminal of the fourth switching device S4 may be connected to each other.

The third switching device S3 and the fourth switching device S4 may supply a current received through the second node N2 to the auxiliary inductor device La.

The auxiliary inductor device La may store energy received according to switching of the third switching device S3 and the fourth switching device S4 to reduce switching loss and a level of a current flowing in the first switching device S1, thereby soft-switching the first switching device S1.

After the first switching device S1 is turned off, the power passing unit 300 may soft-switch the third switching device S3 and the fourth switching device S4 to directly form a power path between the first inductor L1 and the fourth node N4 through the auxiliary inductor device La, and thus, a significant amount of power that is directly transmitted with high efficiency is output directly to the fourth node N4 without switching loss.

When the first switching device S1 is turned on, the power passing unit 300 may linearly and slowly increase the current flowing in the first switching device S1 to soft-switch the first switching device S1 using current characteristics of the auxiliary inductor device La, thereby removing turn-on loss of the first switching device S1 and turn-off loss of the third and fourth switching devices S3 and S4.

Furthermore, when a path passing through the second switching device S2 is blocked, the power passing unit 300 may linearly and slowly increase a current flowing in the third and fourth switching devices S3 and S4 using the current characteristics of the auxiliary inductor device La to linearly and slowly decrease a current flowing in the second switching device S2, thereby removing turn-off loss of the second switching device S2 and turn-on loss of the third and fourth switching devices S3 and S4.

That is, according to an embodiment of the present disclosure, the motor driving apparatus directly forms a current path between the first inductor L1 and the fourth node N4 through the power passing unit 300 to output the remaining amount of voltage and an amount of power required for current conversion through the bidirectional converter 200 to a load as well as to directly output a significant amount of power to the load through the auxiliary inductor device La without switching loss.

As a result, according to an embodiment of the present disclosure, the motor driving apparatus may reduce current loss of respective switching devices using the power passing unit 300 to enhance DC-DC conversion efficiency.

The inverter 400 refers to a DC/AC power converter converting DC power to AC power and transmitting average power to an AC side from a DC side. The inverter 400 may be classified as a voltage source inverter and a current source inverter according to a power type.

The inverter 400 may receive power from a DC voltage source (battery) and function as an electric motor (motor). The inverter 400 may be connected between the base power source and the fourth node N4 of the bidirectional converter 200 and may receive stable power.

In general, when the inverter 400 functions as an electric motor, a voltage of a battery tends to decrease. However, the motor driving apparatus according to an embodiment of the present disclosure may be configured in such a manner that the bidirectional converter 200 boosts the decreased voltage to allow the inverter 400 to be stably driven as an electric motor.

The inverter 400 may function as a generator and provide a regenerated voltage to the motor driving apparatus. A load may be connected between the first node N1 and the base power source and the inverter may be connected between the fourth node N4 and the base power source such that the bidirectional converter 200 may receive power from the inverter.

In general, a regenerated voltage having a high voltage level may not be stored in a battery. However, the motor driving apparatus according to an embodiment of the present disclosure may be configured in such a manner that the bidirectional converter 200 may reduce the high regenerated voltage to a low level voltage (buck operation) and thus may charge a power source battery with stable power to re-supply power to the motor driving apparatus.

So far, the case in which the motor driving apparatus according to an embodiment of the present disclosure functions as an SEPIC converter has been described. It would be obvious to those of ordinary skill in the art that the motor driving apparatus may function as a ZETA converter when locations of the power input unit and the load are exchanged with each other in the aforementioned case, and thus, this will not be described in detail.

That is, when the motor driving apparatus functions as a ZETA converter, a load is connected between the first node N1 and the base power source and the power input unit may be connected between the fourth node N4 and the base power source.

When the motor driving apparatus according to an embodiment of the present disclosure functions as a ZETA converter, the second switching device S2 may replace a function of the first switching device S1.

The additional power transfer path formed by the power passing unit 300 may perform a direct power transfer between an input and an output.

In this case, when the motor driving apparatus functions as an SEPIC converter, an input-output conversion ratio may be represented according to Vo/Vi=(1−D2)/(1−D1). In addition, when the motor driving apparatus functions as a ZETA converter, an input-output conversion ratio may be represented according to Vo/Vi=(1−D1)/(1−D2).

Here, D1 is an on-ratio of the first switching device S1 and D2 is an off-ratio of the second switching device S2.

The motor driving apparatus according to an embodiment of the present disclosure may freely boost or reduce a voltage between input and output unlike a conventional bidirectional converter. For example, when a voltage of 10 to 20 V is input and a voltage of 10 to 20 V is output, even in a case in which voltage ranges between input and output overlap each other, the motor driving apparatus according to an embodiment of the present disclosure may also used.

When power is transferred to the additional power transfer path, the motor driving apparatus according to an embodiment of the present disclosure is configured in such a manner that a voltage applied between the first inductor L1 and the second inductor L2 is reduced to Vi-Vo, thereby reducing current ripples.

When the ripple current is reduced, rms current in a circuit is reduced to reduce inductor dc resistance loss and capacitor DC resistance loss, thereby enhancing efficiency. That is, as time for which power is transferred to the additional power transfer path is increased, an effect of enhancing efficiency may be improved.

In addition, the auxiliary inductor device La on the additional power transfer path may induce soft current commutation between switching devices to facilitate zero current switching (ZCS).

The motor driving apparatus according to an embodiment of the present disclosure may replace an existing diode with an active switching device to facilitate zero current switching (ZCS), thereby reducing switching-on loss.

In addition, when an internal diode in a switching device is opened, if the switching device is turned on and off, zero current switching (ZCS) may be enabled.

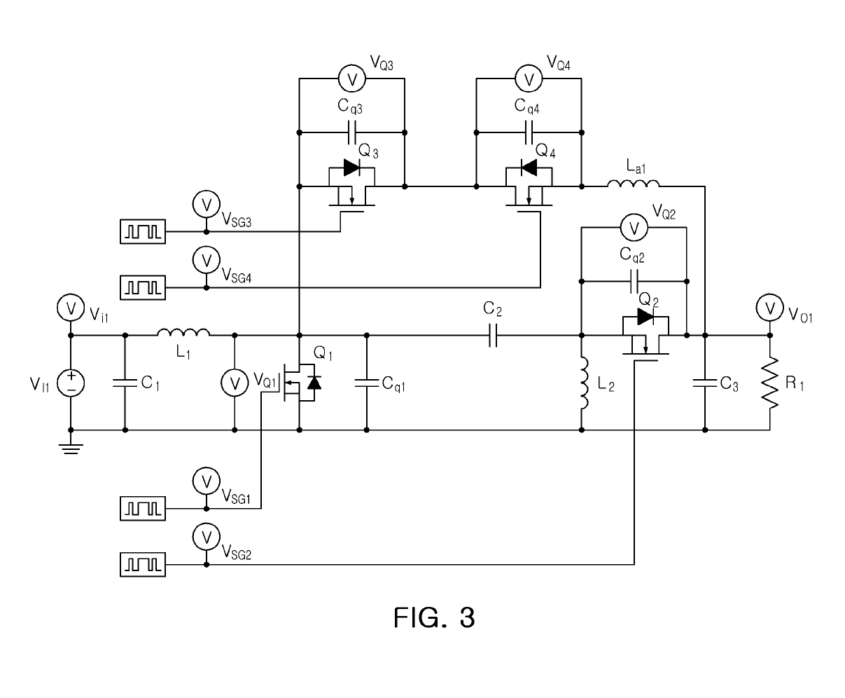

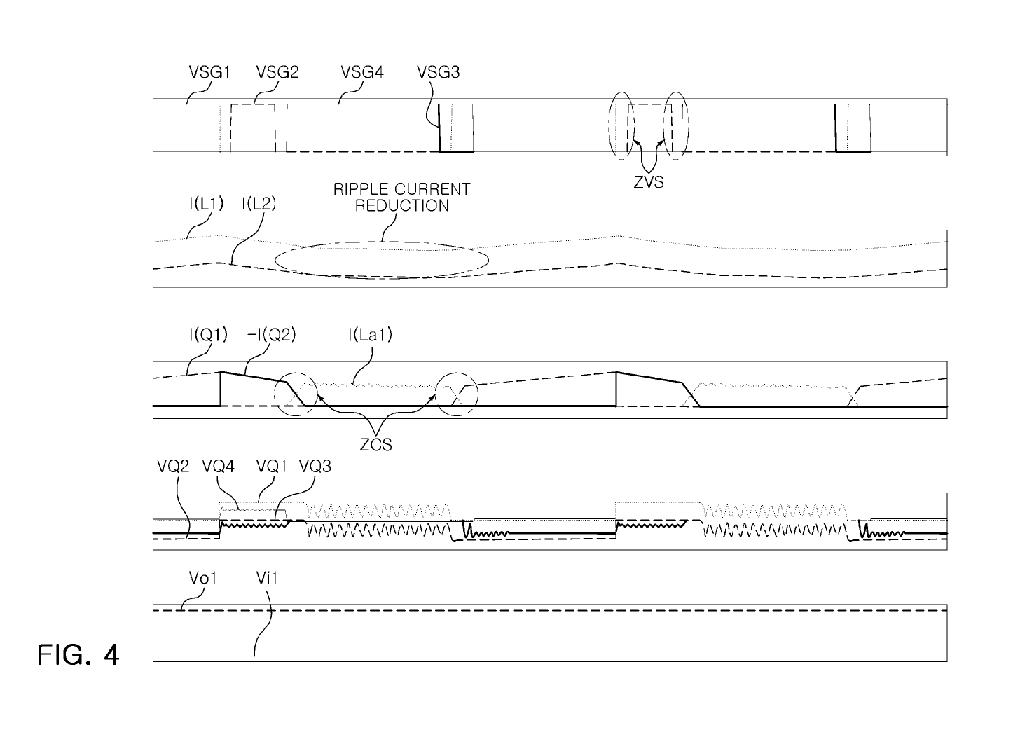

FIG. 3 is a circuit diagram illustrating a simulation test of the motor driving apparatus illustrated in FIG. 2 and illustrates an SEPIC converter operation. FIG. 4 illustrates waveforms of components of the circuit illustrated in FIG. 3.

As seen from FIG. 4, the amount of inductor ripple current was reduced due to an additional power transfer path.

ZCS and ZVS of switching devices may be confirmed according to appropriate switch controlling and soft current commutation of the auxiliary inductor device La.

That is, it may be seen that zero current switching (ZCS) may be enabled when a switching device Q1 is turned on. In addition, it may be seen that zero current switching (ZCS) may be enabled when a switching device Q2 is turned on and off.

It may be seen that zero current switching (ZCS) may be enabled when an internal diode DQ2 of the switching device Q2 is turn off. It may be seen that zero current switching (ZCS) may be enabled when an internal diode DQ3 of a switching device Q3 is turned on and off.

It may be seen that ZCS may be enabled when switching devices Q3 and Q4 are turned on and off. In addition, it may be seen that ZVS of the switching devices Q2 and Q3 may be enabled.

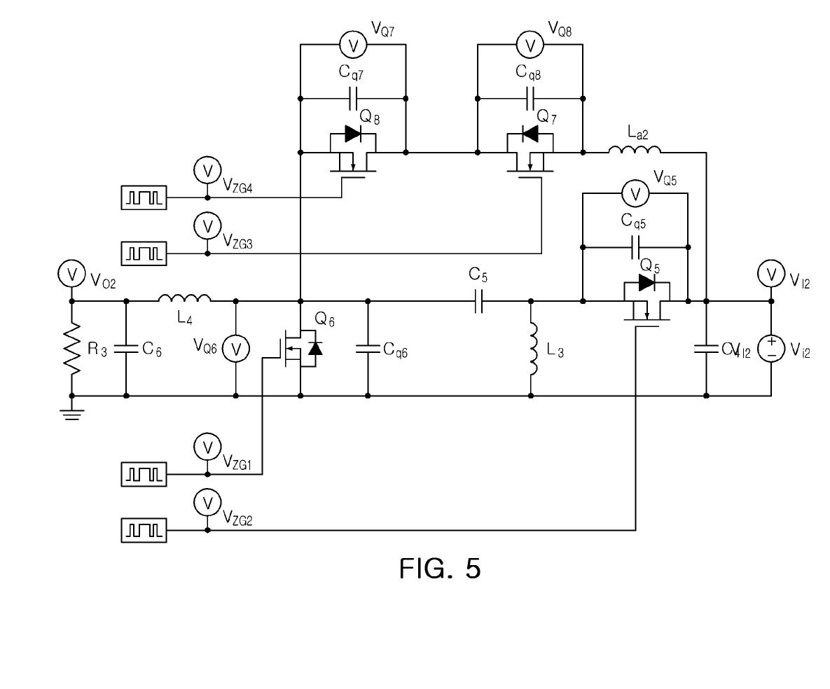

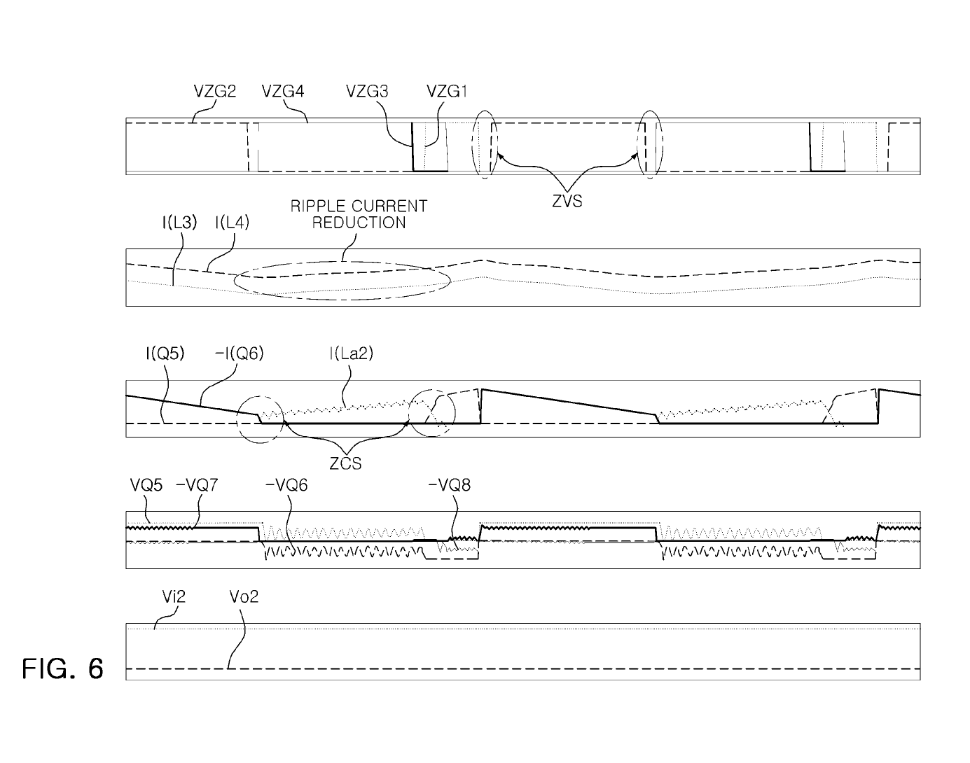

FIG. 5 is a circuit diagram illustrating a simulation test of the motor driving apparatus illustrated in FIG. 2 and illustrates a ZETA converter operation. FIG. 6 illustrates waveforms of components of the circuit illustrated in FIG. 5.

As seen from FIG. 6, the amount of inductor ripple current is reduced due to an additional power transfer path.

ZCS and ZVS of switching devices may be seen according to appropriate switch control and soft current commutation of the auxiliary inductor device La. That is, it may be seen that ZCS may be enabled when a switching device Q5 is turned on. It may be seen that ZVS may be enabled when a switching device Q6 is turned on and off.

It may be seen that ZCS may be enabled when an internal diode DQ6 of a switching device Q6 is turned off. It may be seen that ZCS may be enabled when an internal diode DQ7 of a switching device Q7 is turned on and off.

It may be seen that ZCS may be enabled when switching devices Q7 and Q8 are turned on and off. In addition, it may be seen that ZVS of the switching devices Q6 and Q7 may be enabled.

As set forth above, according to exemplary embodiments of the present disclosure, a motor driving apparatus capable of boosting and reducing a voltage bidirectionally with high efficiency, using an inverter structure including a bidirectional switching converter disposed in front of a DC link capacitor used as a main power source of a voltage source inverter may be provided.

While exemplary embodiments have been shown and described above, it will be apparent to those skilled in the art that modifications and variations could be made without departing from the spirit and scope of the present disclosure as defined by the appended claims.

What is claimed is:

1. An motor driving apparatus comprising:
a bidirectional converter including an energy storage unit and converting power bidirectionally;
an inverter receiving the power from the bidirectional converter and driving a motor; and
a power passing unit transferring energy stored in the energy storage unit of the bidirectional converter to the inverter.

2. The motor driving apparatus of claim 1, wherein the bidirectional converter includes:
a first inductor connected between a first node and a second node;
a first switching device connected between the second node and a base power source and switched according to a first switching signal;
a separation capacitor connected between the second node and a third node;
a second inductor connected between the third node and the base power source; and
a second switching device connected between the third node and a fourth node.

3. The motor driving apparatus of claim 2, further comprising:
an input capacitor connected between the first node and the base power source; and
an output capacitor connected between the fourth node and the base power source.

4. The motor driving apparatus of claim 3, wherein the power passing unit is formed between the second node and the fourth node.

5. The motor driving apparatus of claim 4, wherein the power passing unit includes a third switching device, a fourth switching device, and an auxiliary inductor connected to one another in series.

6. A motor driving apparatus comprising:
a SEPIC and ZETA converter including an energy storage unit and converting power bidirectionally;
an inverter receiving the power from the SEPIC and ZETA converter and driving a motor; and
a power passing unit transferring energy stored in the energy storage unit of the SEPIC and ZETA converter to the inverter.

7. The motor driving apparatus of claim 6, wherein the SEPIC and ZETA converter includes:
a first inductor connected between a first node and a second node;
a first switching device connected between the second node and a base power source and switched according to a first switching signal;
a separation capacitor connected between the second node and a third node;
a second inductor connected between the third node and the base power source; and
a second switching device connected between the third node and a fourth node.

8. The motor driving apparatus of claim 7, further comprising:
an input capacitor connected between the first node and the base power source; and
an output capacitor connected between the fourth node and the base power source.

9. The motor driving apparatus of claim 8, wherein the power passing unit is formed between the second node and the fourth node.

10. The motor driving apparatus of claim 9, wherein the power passing unit includes a third switching device, a fourth switching device, and an auxiliary inductor connected to one another in series.

11. The motor driving apparatus of claim 6, wherein an input power unit is connected between the first node and the base power source, and the inverter is connected between the fourth node and the base power source.

12. The motor driving apparatus of claim 6, wherein a load is connected between the first node and the base power source, and the inverter is connected between the fourth node and the base power source to receive the power from the inverter.
